(19) United States
(12) Patent Application Publication
(10) Pub. No.: US 2017/0310206 A1
(43) Pub. Date: Oct. 26, 2017

(54) DEVICE AND METHOD FOR CHARGING A BATTERY FROM A THREE-PHASE NETWORK, HAVING A DEGRADED CHARGING MODE

(71) Applicant: RENAULT s.a.s., Boulogne Billancourt (FR)

(72) Inventors: Pedro KVIESKA, Versailles (FR); Ludovic MERIENNE, Gif Sur Yvette (FR)

(73) Assignee: RENAULT s.a.s., Boulogne Billancourt (FR)

(21) Appl. No.: 15/517,178

(22) PCT Filed: Oct. 12, 2015
(86) PCT No.: PCT/FR2015/052741

§ 371 Date: Apr. 6, 2017

(30) Foreign Application Priority Data
Oct. 24, 2014 (FR) 1460243

(51) Int. Cl. H02M 1/32; H02J 7/02

(52) U.S. Cl. CPC H02M 1/32; H02J 7/02

(57) ABSTRACT

A device and method for charging a battery from a three-phase network, having a degraded charging mode, for example a battery of an electric traction automotive vehicle. The device includes a first filtering stage configured to be connected to the three-phase network, a voltage step-down stage connected to the filtering stage, a voltage step-up stage configured to be connected to the battery and coupled to the voltage step-down stage via an inductive component, a regulating unit configured to impose cyclic switching ratios on the voltage step-down stage and on the voltage step-up stage, and a device for comparing operating temperature of the regulating unit with a threshold value and controlling the charging based on two phases of the three-phase network when the operating temperature of the regulating unit exceeds the threshold value.

The present invention relates to a device for charging a high-voltage battery, in particular a drive battery for an automotive vehicle, from a three-phase power supply network.

In high-voltage battery recharging systems, electrical power from the network is transmitted to the battery in succession through two converters: a buck converter and a boost converter. These two converters allow the voltage ratio between their output terminal and their input terminal to be stepped down and stepped up, respectively, by successively opening and closing a series of switches at a frequency that is controlled according to the desired output voltage and/or output current.

Such recharging systems are, for example, described in the patent application FR 2 943 188 which pertains to an embedded recharging system for an automotive vehicle, allowing a vehicle battery to be recharged from a three-phase or single-phase circuit. The recharging circuit incorporates the coils of an electric machine which also provides other functions such as current generation or vehicle propulsion. Reference may also be made to the document FR 2 974 253 which describes a device for regulating the voltage buck circuit and the voltage boost circuit of a recharging device and which allows, despite the presence of an RLC filter at the input of the device, a phase difference between the current and the voltage taken from a single-phase power supply network to be kept low.

Furthermore, when a battery charger is used under relatively warm climatic conditions, its temperature is liable to increase beyond an acceptable value resulting in charging being interrupted in order to allow the device to cool down.

Various components may be the cause of such an interruption. In particular, the microcontroller of the unit for regulating the voltage buck and boost circuits is liable to generate a great deal of heat.

Such an interruption is maintained until the temperature returns to below a predetermined threshold, on which charging is resumed. This process is repeated if the temperature rises again, which is generally the case if the climatic conditions do not change. The complete charging operation may therefore ultimately take a very long time.

In this regard, the document CN 203415961 describes a battery charger in which provision is made for interruptions in the event of an increase in the temperature of internal components of the charger beyond a threshold value.

It is also known practice, from the documents US 2007069690 and US 2014084859, to adjust the power of the charger according to the thermal stresses to which it is subjected.

It has been demonstrated that the strategies based on interrupting charging as implemented in the prior art cannot be applied when the charger charges the battery from a three-phase network.

Specifically, a strategy that consists of reducing the charging power so that the temperature decreases and of interrupting the charging operation when the power reaches zero is unsuitable when the charger is connected to a three-phase network. It has actually been demonstrated that the heating of the microcontroller (CPU) is proportional to its level of usage, such that its temperature mainly depends on its CPU load, i.e. on the computing power implemented thereby. Thus, limiting the charging of the battery does not allow the temperature of the microcontroller to be lowered if its computing power is not decreased. When the temperature of the microcontroller exceeds the threshold value, the only way to cause its temperature to decrease is to take it out of operation.

In light of the above, the invention proposes the avoidance of charging interruptions and the optimization of the recharging time of a battery, in particular under unfavorable climatic conditions, through the implementation of a degraded charging mode when the temperature of the regulating unit increases. One subject of the invention is therefore, according to a first aspect, a device for charging a battery, in particular a battery for an electric-drive automotive vehicle, from a three-phase power supply network, this device comprising a filtering stage that is intended to be connected to the three-phase network, a voltage buck stage connected to the filtering stage, a voltage boost stage that is intended to be connected to the battery and coupled to the voltage buck stage via an inductive component, and at least one regulating unit that is designed to impose chopping duty cycles on the voltage buck stage and on the voltage boost stage.

This device additionally comprises means for comparing the operating temperature of the regulating unit with a first threshold value and means for controlling the charging operation so that it takes place via two phases only of the three-phase network when the operating temperature of the regulating unit exceeds the threshold value.

Thus, the degraded operating mode consists of charging from the three-phase power supply network, but using a degraded mode, analogous to charging from a single-phase network, from only two phases of the three-phase network, thereby requiring a lower level of usage of the microcontroller of the regulating unit.

In one embodiment, the device comprises means for controlling the charging operation so that it takes place via the three phases of the three-phase network when the temperature of the regulating unit is above a second threshold value that is lower than the first threshold value.

The regulating unit preferably additionally includes means for distributing the current flowing through the buck stage between two branches of said buck stage according to the chopping duty cycle imposed on this stage.

In this case, the regulating unit includes means for implementing a regulation of the buck stage which uses a single switch controlled over one current flow branch.

According to another feature of the charging device, the regulating unit includes means for imposing chopping duty cycles on the voltage boost stage and means for compensating for the increase in the output voltage of the voltage buck stage, resulting from charging from the two phases of the network.

Another subject of the invention, according to a second aspect, is a method for charging a battery, in particular a drive battery for an electric-drive automotive vehicle, from a three-phase power supply network, in which the input voltage delivered by the network is filtered, the electrical power is transmitted from the network to the battery via a voltage buck stage and a voltage boost stage that are coupled via an inductive component, and in which the operating temperature of a regulating unit for regulating the voltage buck and boost stage is compared with a first threshold value and the battery is charged from two phases only of the three-phase network when the temperature exceeds said first threshold value. In one mode of implementation, the battery-charging operation is controlled so that it takes place via the three phases of the network once the temperature has returned to below a second threshold value that is lower than the first threshold value.

Advantageously, a chopping duty cycle is calculated for the voltage buck stage and for the voltage boost stage, and the current flowing through the voltage buck stage is distributed between two branches of said buck stage according to the chopping duty cycle imposed on the buck stage.

Advantageously, if the voltage of the phase connected to a first branch of said two phases is higher than the voltage of the phase connected to a second branch of said two phases, a switch in series with a diode of the second branch is closed and the chopping duty cycle is applied to the first branch and, if such is not the case, a switch in series with a diode of the first branch is closed and the chopping duty cycle is applied to the second branch.

Similarly, a third branch of the voltage buck stage is advantageously kept open during the operation of charging from said two phases of the power supply network.

Other aims, features and advantages of the invention will become apparent on reading the following description, which is provided solely by way of non-limiting example and with reference to the appended drawings, in which:

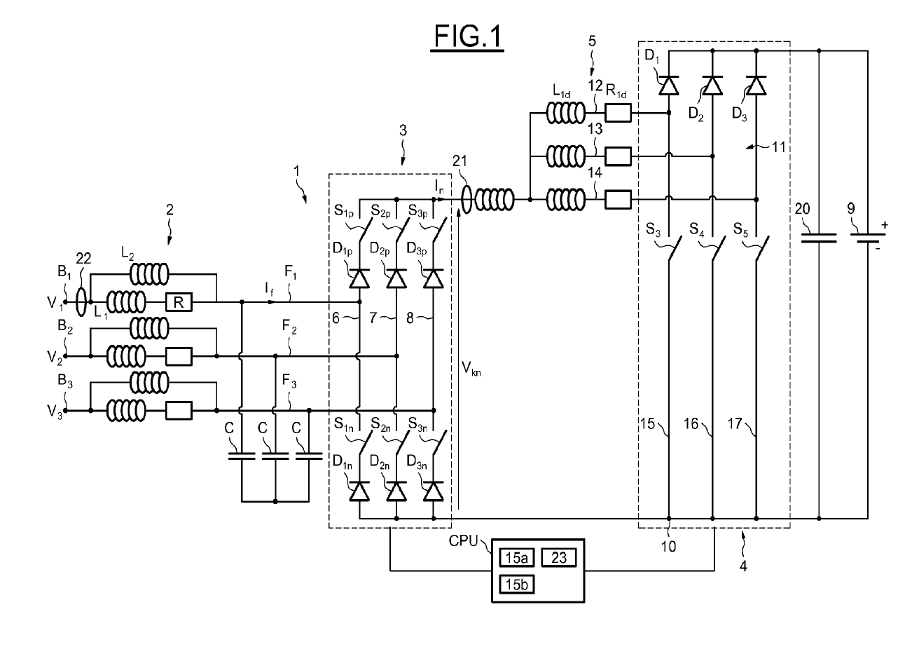

FIG. 1 illustrates a recharging device according to one embodiment of the invention;

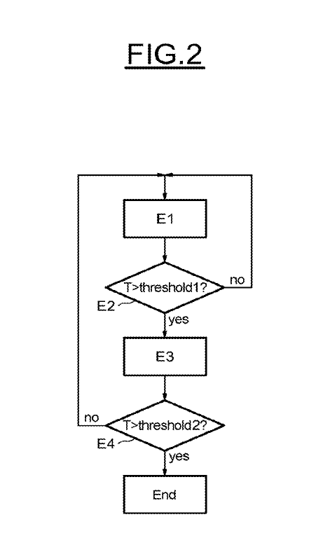

FIG. 2 shows a flow diagram of a recharging method in accordance with the invention.

FIG. 1 schematically presents a device for charging a battery of an electric-drive automotive vehicle from a three-phase power supply network, according to one embodiment of the invention.

The recharging device 1 comprises a filtering stage 2, a voltage buck rectifier stage 3 coupled to the filtering stage 2 and a voltage boost stage 4 coupled to the voltage buck stage 3 via an electric machine 5, here formed by the electric drive motor of the vehicle. At input, the device 1 comprises three terminals B₁, B₂, B₃ that are capable of being coupled to the power supply network.

The input terminals B₁, B₂ and B₃ are coupled to three respective filtering branches of the filtering stage 2. Each filtering branch comprises two branches in parallel, one bearing an inductor of inductance value L₁ and a resistor of resistance value R in series and the other an inductor of inductance value L₂.

The three filtering branches are each coupled at the output to a capacitor of capacitance value C. The resistors of resistance values R, the inductors of inductance values L₁ or L₂ and the capacitors of capacitance value C together form a filter of RLC type at the input of the voltage buck 3.

The voltage buck 3 comprises three parallel branches 6, 7 and 8, each including two switches such as S₁ₚ and S₁ₙ, S₂ₚ and S₂ₙ, and S₃ₚ and S₃ₙ that are controlled by a regulating unit CPU. Each branch includes two diodes D₁ₚ and D₁ₙ, D₂ₚ and D₂ₙ, and D₃ₚ and D₃ₙ, each connected in series with one of the two switches of the branch. Each input of the voltage buck is connected, via a branch F₁, F₂ and F₃, to a connection point located between two switches, such as S₁ₚ and S₁ₙ, of one and the same branch 6, 7 and 8.

The two common ends of the branches 6, 7 and 8 form two output terminals of the voltage buck 3. One of the terminals is connected to the “-” terminal of the battery 9 and to a first input 10 of the voltage boost 4. The other terminal is connected to a first neutral terminal of the electric machine 5, the other terminal of which is connected to a second triple input 11 of the voltage boost 4.

As can be seen, the electric machine 5 is here formed by the combination of three branches 12, 13 and 14 in parallel, each comprising an inductor L_{1d} in series with a resistor R_{1d}.

The voltage boost stage 4 comprises three branches 15, 16 and 17 in parallel, each comprising a switch S₃, S₄ and S₅ in series with a diode D₁, D₂ and D₃.

The three branches 12, 13 and 14 of the electric machine are connected between the switch and the diode of the three branches 15, 16 and 17, respectively. These three branches 15, 16 and 17 connect the first input 10 of the voltage boost to the “+” terminal of the battery 9.

Lastly, it can be seen that a capacitor 20, intended to keep the voltage across the terminals of the battery 9 relatively stable, is connected to the terminals of the battery 9. A charge monitoring module for monitoring the charge of the battery (not shown) is also provided in order to deliver a setpoint value reflecting, according to the charge level of the battery, the optimum amperage of the current to be input via the “+” terminal of the battery 9. This charge monitoring module is intended to transmit the battery current setpoint value to the regulating unit.

Furthermore, measurement modules are provided in the charging device in order to transmit current and voltage values measured at characteristic points of the charging device to the regulating unit. Specifically, it can be seen in FIG. 1 that the device is equipped with a member 21 for measuring the current In flowing through the electric machine, a member 22 for measuring the value of the amperage of a filtered current If at the input of the RLC filter and members for measuring or for calculating the values of the input supply voltages V₁, V₂ and V₃ of the network, of the output voltage Vₖₙ of the buck stage 3 and of the voltage of the battery.

Lastly, the regulating unit CPU is equipped with means 23 for measuring the temperature. Comparison means, for example embedded within the regulating unit CPU or embedded within a computer of the vehicle, compare the measured temperature of the regulating unit and, in particular, of the microcontroller of the regulating unit with a first threshold value beyond which the charging operation takes place according to a degraded mode.

In this regard, provision may be made for a first threshold value of between 90 and 100°. However, other threshold values may be used according to the type of component used.

When the temperature of the microcontroller of the regulator exceeds the threshold value, the regulating unit initiates the opening of the switches of one of the branches 6, 7 and 8 of the voltage buck stage 3 so as to prevent all flow of current through this branch.

In this instance, this means opening the switches S₂ₚ and S₂ₙ of the second branch 7 so as to adopt a charging mode that is analogous to charging from a single-phase network for which the computing demands on the microcontroller are lower.

When the regulating unit detects that the measured temperature of the microcontroller has returned to below a second threshold value that is lower than the first threshold value, it initiates the re-closing of the two switches S₂ₚ and S₂ₙ in order to return to three-phase charging.

Stated otherwise, provision is made for a hysteresis in order to avoid overly frequent changes of charging mode.

Conventionally, the voltage buck stage 3 is responsible for regulating the charging power. The voltage boost stage 4, for its part, regulates the current In arising from the first stage.

The power regulation operation implemented during the degraded charging mode is similar to that when charging from a single-phase circuit. However, the equivalent single-phase network used when charging in degraded mode delivers a higher voltage. Specifically, with three phases, the value of the voltage between two phases is 220×√3, i.e. 380 volts (RMS). As such, the power regulation stage 15a of the regulating unit that is dedicated to regulating the power compensates for its output voltage Vₖₙ through the use of a feedback loop.

The power regulation stage of the regulating unit furthermore calculates a chopping duty cycle for the switches S₁ₚ, S₁ₙ, S₃ₚ and S₃ₙ of the buck stage 3 in order to distribute the current between each of its phases.

In the case of a duty cycle of 50% of the current flowing from the network to the output of the buck stage 3, and if the value of the current of the neutral phase is 100 A, the current at the input of the buck stage 3 will be 50 A. In the case of a duty cycle of 50% of the current flowing to the power supply network from the input of the buck stage 3, and if the value of the current of the neutral phase is 100 A, the current at the input of the buck stage 3 will be −50 A. As such, for practical reasons, duty cycles with sign values of between −1 and 1 times the neutral current, which represents the current at the input of the voltage buck stage 3, are used in this application by convention. Stated otherwise, if this duty cycle is positive, the current arrives via the first phase, in this instance through the first branch 6, and leaves via the third phase, in this instance via the third branch 8.

Conversely, if the duty cycle is negative, the current arrives via the third phase and leaves via the first phase.

The stage 15b for regulating the voltage boost stage 4 also imposes duty cycles for opening the switches S₃, S₄ and S₅. It controls in particular the value of the charging current so as to compensate for the increase in the voltage Vₖₙ imposed by the duty cycles for opening the switches of the first and third branches 6 and 8.

It is known that single-phase regulation generates duty cycles that are synchronized with the voltage.

Thus, the duty cycle arising from the regulation of the voltage buck stage 3 will be positive if the voltage of the first phase is higher than the voltage of the third phase and will be negative in the contrary case. In order to distribute the current between the first and third phases, the following procedure is carried out starting from the regulation command α:
the switches S₁ₙ and S₃ₙ are kept permanently closed and the switches S₂ₚ and S₂ₙ are kept permanently open;
the absolute value of the duty cycle α is calculated on the basis of the ratio between the desired current and the neutral current In;
if the duty cycle is positive, this duty cycle is applied to the switch S₁ₚ and the switch S₃ₚ is permanently closed;
if the duty cycle is negative, this duty cycle is applied to the switch S₃ₚ and the switch S₁ₚ is permanently closed.

Thus, in the case in which the duty cycle is positive, the voltage on the first phase is higher than the voltage on the third phase, such that the current will flow by arriving via the first phase and by returning via the third phase when the switch S₁ₚ is closed, regardless of whether the switch S₃ₚ is in the open or closed state.

When the switch S₃ₚ is closed, the diode D₃ₚ of the branch 8 acts as a flyback diode when the switch S₁ₚ is opened.

In the case in which the duty cycle is negative, the same reasoning applies between the first and third phases. The diode D₁ₚ acts as a flyback diode when the switch S₃ₚ is opened.

A flyback diode is always present, in any case, since there is always a closed switch on at least one of the branches of the voltage buck stage 3 when the duty cycle changes sign. The path along which the flyback current flows uses both diodes of one and the same branch.

It has been demonstrated that the regulation operation actually controls only one switch in each computing step, thereby allowing the computing load on the microcontroller to be considerably decreased and therefore allowing it to be cooled without interrupting charging. Five switches are either permanently closed or permanently open over one entire period, only one switch actually being controlled.

In practice, a load level on the microcontroller is reached that is smaller than that measured in the case of conventional single-phase charging.

Lastly, reference is made to FIG. 2 which illustrates the main phases of a charging method according to the invention.

As mentioned above, when the charger is operating normally, i.e. when charging from a three-phase network, the voltage delivered by the power supply network is first filtered, then the power arising from the network is delivered to the voltage rectifier stage 3 in order to be rectified, then to the voltage boost stage 4, passing through the electric motor of the vehicle, which may be likened to resistors in series with inductive coils, finally reaching the battery in order to charge it at a constant current.

In a first step E1, the temperature of the regulating unit CPU, and in particular the temperature of the microcontroller, is measured;

in the following step E2, a test is carried out in order to determine whether the measured temperature T is above a first threshold value threshold1.

If such is not the case, the method returns to the preceding step E1.

If such is the case, charging in degraded mode is implemented (step E3) by distributing the current flowing through the voltage buck stage between the branches of the first and third phases (step E3), while keeping the branch 7 open throughout the phase of charging in degraded mode.

In the following step E4, a test is carried out in order to detect whether the temperature has fallen below a second threshold value, threshold2, that is lower than the first threshold value.

If such is the case, the procedure of charging in degraded mode ends and charging in three-phase mode, i.e. from the three phases of the network, is instigated.

If such is not the case, the method returns to the preceding step E1.

It should be noted that as a variant, the charging device according to the invention uses multiple regulating units, for example one unit for controlling the voltage buck stage that is physically separate from the unit for controlling the voltage boost stage. The principle of the invention remains unchanged in this variant embodiment of the invention, the latter making it possible to momentarily limit the computing resources required to recharge the drive battery.

1-10. (canceled)

11. A device for charging a battery, or a battery for an electric-drive automotive vehicle, from a three-phase power supply network, comprising:
a first filtering stage configured to be connected to the three-phase network;
a voltage buck stage connected to the filtering stage;
a voltage boost stage configured to be connected to the battery and coupled to the voltage buck stage via an inductive component;
at least one regulating unit configured to impose chopping duty cycles on the voltage buck stage; and
means for comparing an operating temperature of the regulating unit with a first threshold value and means for controlling the charging operation to take place via two phases only of the three-phase network when the operating temperature of the regulating unit exceeds the first threshold value.

12. The device as claimed in claim 11, further comprising means for controlling the charging operation to take place via the three phases of the three-phase network when the temperature of the regulating unit is below a second threshold value that is lower than the first threshold value.

13. The device as claimed in claim 11, wherein the regulating unit includes means for distributing current flowing through the buck stage between two branches of the voltage buck stage according to the chopping duty cycle imposed on this stage.

14. The device as claimed in claim 13, wherein the regulating unit includes means for implementing a regulation of the buck stage that uses a single switch controlled over one current flow branch.

15. The device as claimed in claim 11, wherein the regulating unit includes means for imposing chopping duty cycles on the voltage boost stage and means for compensating for increase in the output voltage of the voltage buck stage, resulting from charging from the two phases of the network.

16. A method for charging a battery, or a drive battery for an electric-drive automotive vehicle, from a three-phase power supply network, comprising:
filtering the input voltage delivered by the network;
transmitting electrical power from the network to the battery via a voltage buck stage and a voltage boost stage that are coupled via an inductive component;
comparing an operating temperature of a regulating unit for regulating the buck stage with a first threshold value; and
charging the battery from two phases only of the three-phase network when the temperature exceeds the first threshold value.

17. The method as claimed in claim 16, wherein the battery-charging operation is controlled to take place via the three phases of the network when the measured temperature is below a second threshold value that is lower than the first threshold value.

18. The method as claimed in claim 16, further comprising:
calculating a chopping duty cycle for the voltage buck stage and for the voltage boost stage; and
distributing the current flowing through the voltage buck stage between two branches of the buck stage according to the chopping duty cycle imposed on the buck stage.

19. The method as claimed in claim 18, wherein, if the voltage of the phase connected to a first branch of the two phases is higher than the voltage of the phase connected to a second branch of the two phases, a switch in series with a diode of the second branch is closed and the chopping duty cycle is applied to the first branch and, if such is not the case, a switch in series with a diode of the first branch is closed and the chopping duty cycle is applied to the second branch.

20. The method as claimed in claim 19, wherein a third branch of the voltage buck stage is kept open during an operation of charging from the two phases of the power supply network.
